(19) United States
(12) Patent Application Publication
(10) Pub. No.: US 2003/0051607 A1
(43) Pub. Date: Mar. 20, 2003

(54) Shish Kabob apparatus

(76) Inventors: George F. Cassell, Lake Lure, NC (US); Guy N. Palmire, Ardmore, OK (US); Stanley Kitching III, Hawthorne, FL (US)

Correspondence Address: Randall K. McCarthy, Fellers, Snider, Blankenship,, Bailey & Tippens, P. C., Bank One Tower, 100 North Broadway, Suite 1700, Oklahoma City, OK, 73102-8820, US

(21) Appl. No.: 10/197,024

(22) Filed: Jul. 17, 2002

Related U.S. Application Data
(60) Provisional application No. 60/306,052, filed on Jul. 17, 2001.

(51) Int. Cl. A47J 37/04

(52) U.S. Cl. 99/419

(57) ABSTRACT

A shish kabob apparatus for cooking food items over the firebox of an outdoor grill. The shish kabob apparatus includes a planar support that is configured for placement onto the firebox of the outdoor grill. A number of removable skewer members are provided each comprising an elongated body portion having a proximal end and a distal end. The proximal end is configured for releasable engagement with a corresponding support member on the planar support to support the skewer members along an axis substantially normal to the planar support. The distal end is configured to skewer, or pierce, the food items to enable the food items to be adjacently stacked and supported along the body portion.

### RELATED APPLICATIONS

This application claims priority to U.S. Provisional Application No. 60/306,052 entitled SHISH KABOB APPARATUS filed Jul. 17, 2001.

### FIELD OF THE INVENTION

The present invention relates to the field of cooking, and cooking apparatus, and in particular, to a novel skewer for cooking shish kabobs or the like. More specifically, the invention relates to a shish kabob having one or more removable skewer members.

### BACKGROUND

In general the invention relates to the cooking of food in shish kabob style over a charcoal fire or hot grill.

Typically, a shish kabob involves the cooking of cubed size pieces of beef or fowl along with tomatoes, shrimp, potatoes, mushrooms, green peppers, onions, and a variety of other items. Usually, in this style of cooking the food item is about the size of the palm of one's hand or smaller. Larger items might also be held on a skewer rod and cooked over a grill, such as chicken, Cornish game hen, duck and the like. Naturally, these larger items require that they be firmly secured and not spin during cooking.

It is known in the art that shish-kabobs are made from metal, usually have sharp tips, and are often provided with wooden handles securely fitted to the metal body of the skewer and are situated so that the skewer member are transversely arranged over the grill.

It would be desirable to be able to provide for the simultaneous shish kabob cooking of food items without the need for additional rotisserie equipment or manner of operation, but still yielding a uniform technique can be undertaken for all items to be cooked in a simple arrangement.

### SUMMARY OF THE INVENTION

The present invention provides a shish kabob apparatus for cooking food items over a firebox of an outdoor grill.

In accordance with preferred embodiments, the shish kabob apparatus includes a planar support that is configured for placement onto the firebox of the outdoor grill. A number of removable skewer members are provided each comprising an elongated body portion having a proximal end and a distal end. The proximal end is configured for releasable engagement with a corresponding support member on the planar support. The distal end is configured to skewer, or pierce, the food items to enable the food items to be adjacently stacked and supported along the body portion.

The proximal end of each skewer member and the corresponding support member of the planar support are configured to support the skewer member so that the body portion lies along an axis that is substantially normal to the planar support.

### BRIEF DESCRIPTION OF DRAWINGS

FIG. 1 is an isometric view of the shish kabob apparatus constructed in accordance with preferred embodiments of the present invention.

FIG. 2 is an isometric view of the top of the planar support of the shish kabob apparatus of FIG. 1.

FIG. 3 is a plan view of the support skewer member of the shish kabob apparatus of FIG. 1.

FIG. 4 is a plan view of the planar support of the shish kabob apparatus of FIG. 1.

### DETAILED DESCRIPTION

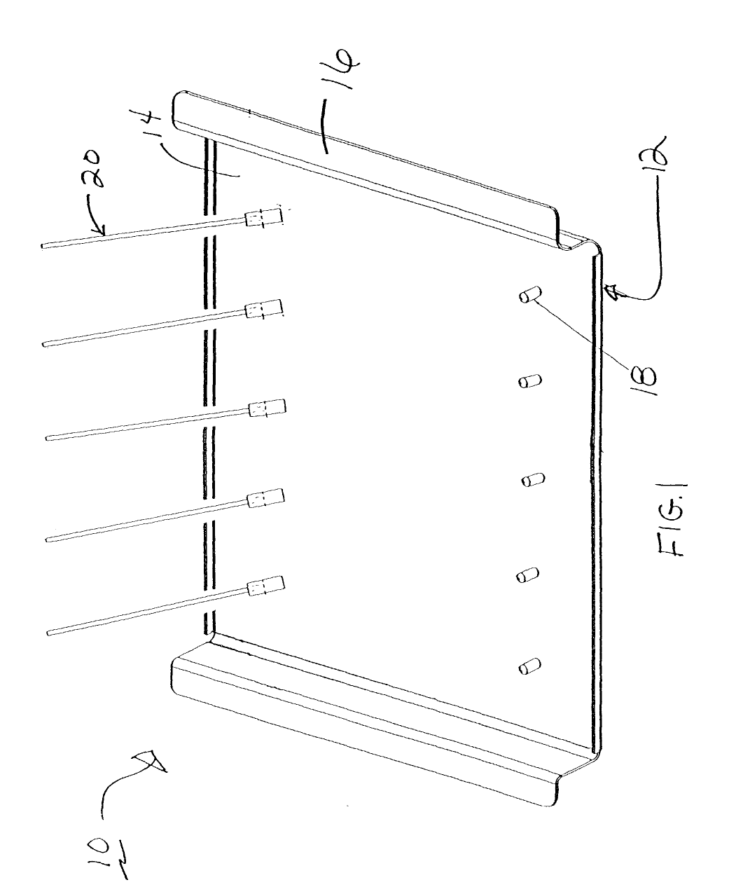

Referring generally to the drawings, and in particular to FIG. 1, depicted therein is a shish kabob apparatus 10 constructed in accordance with preferred embodiment of the present invention. The shish kabob apparatus 10 is placed over a grill firebox or other heat source to support and cook food items.

The shish kabob apparatus 10 has a planar support 12 with a base 14, side rails 16, and support members 18. The support members18 are configured to support a number of skewer members 20 so that the skewer members 20 project in a direction that is substantially normal to the surface of the planar support 12.

The skewer members 20 are shown to be nominally identical to each other, although the skewer members 20 can also be provided with a variety of shapes and sizes to accommodate various food items and cooking conditions. Only five skewer members 20 are shown in FIG. 1 to allow viewing of the support members 18, but it will be understood that the apparatus of FIG. 1 will support up to 10 skewer members (in two rows of five members each). However, this is for purposes of illustration and is not limiting as any number and arrangement of skewer members 20 can be arranged on the planar support, as desired. The planar support 12 and the skewer members 20 are preferably formed from stainless steel.

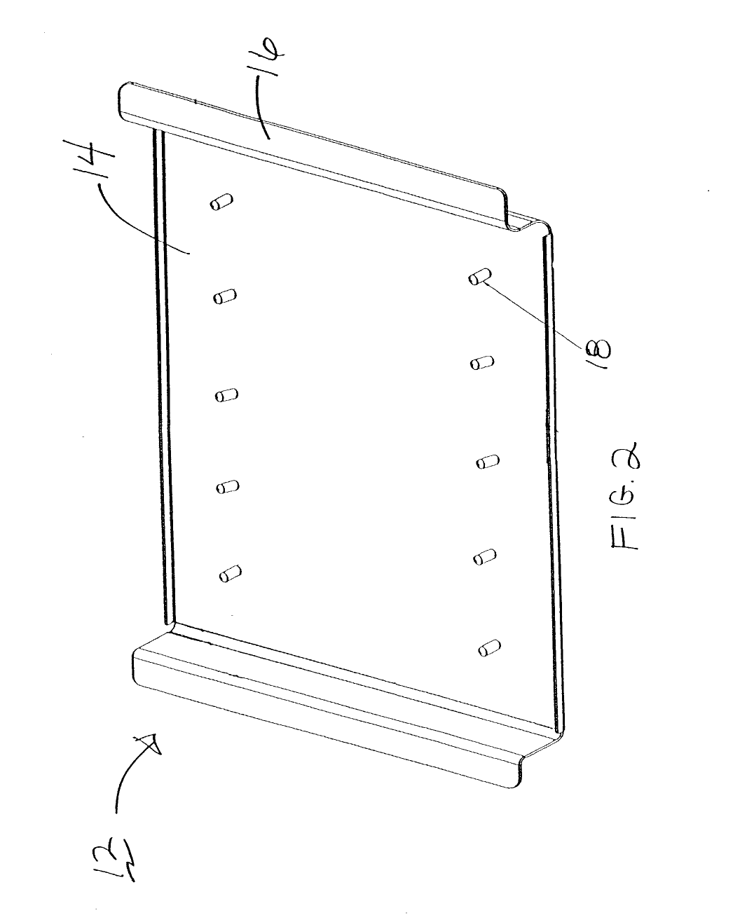

FIG. 2 shows the planar support 12 of the shish kabob apparatus 10. Each support members 18 is firmly attached to the base 14 of the planar support 12 via welding or other suitable process and preferably comprises a solid, cylindrical shape. The support members 18 are each configured to receive and hold a skewer member 20 during cooking operations.

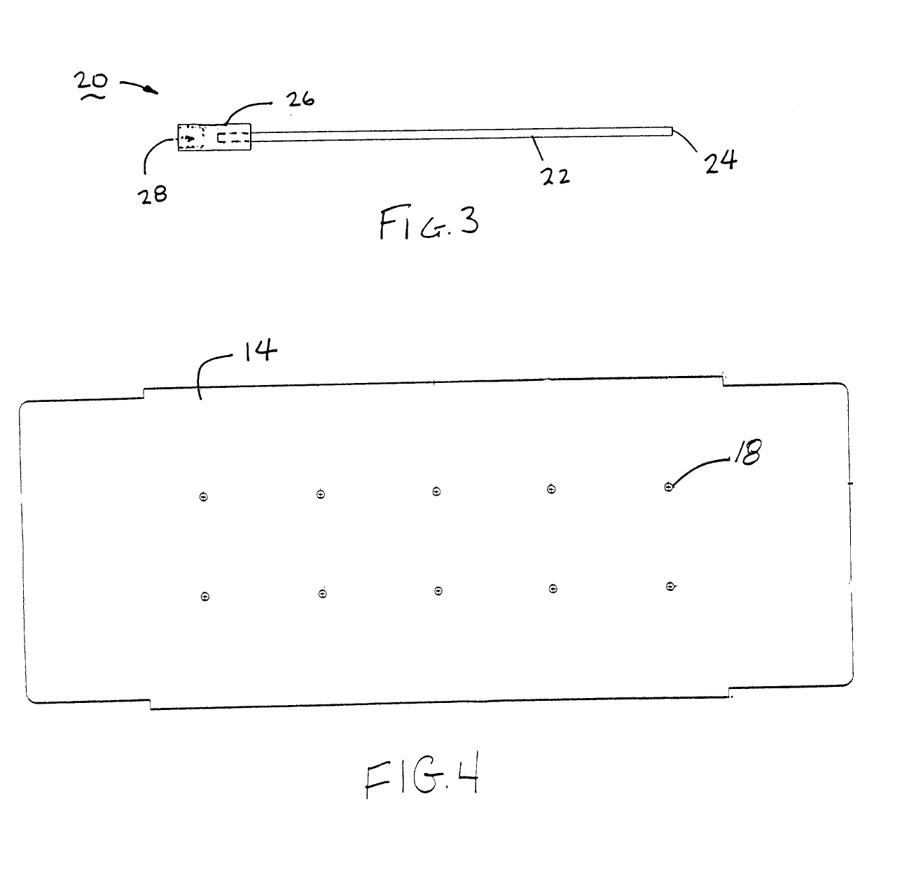

FIG. 3 shows a preferred configuration for the skewer member 20 of the shish kabob apparatus 10. The skewer member 20 comprises an elongated body portion 22 with a distal end 24 and a proximal end 26. The proximal end 26 is detachably mountable to the planar support 12 in cooperation with the corresponding support member 18. In one embodiment the proximal end 26 is preferably provided with a cylindrically shaped recess 28 that fits over the solid support member 18. Alternative configurations for the support member 18 and the proximal end 26 are readily contemplated, however. For example, in another embodiment the support member 18 is provided with a cylindrical shaped recess (not shown) and the proximal end 26 of the body portion 22 provided with a corresponding solid shape that is inserted therein to support the skewer member 20.

Regardless, the skewer member 20 and the planar support 12 are releasably engaged so that the skewer members can be loaded with the desired food items, placed in the upright position on the planar support during cooking, and thereafter removed for distribution of the cooked food items. The removability of the skewer members 20 also promotes ease of cleaning after each use.

The distal end 24 of the skewer member 22 is configured to permit the skewering or piercing of food items which are then passed along and adjacently stacked on the body portion 22. While the distal end 24 is shown as a flat surface, other shapes such as a point or radiused blunt surface capable of piecing and holding food items can readily be used, as desired.

FIG. 4 show a top view of a shape of the base support 12 with the locations of the support members 18 shown as they are placed in an embodiment of the present invention. This shape is capable of being formed into the final planar support configuration of FIGS. 1 and 2.

It is clear that the present invention is well adapted to carry out the objects and to attain the ends and advantages mentioned as well as those inherent therein. While presently preferred embodiments of the invention have been described in varying detail for purposes of the disclosure, it will be understood that numerous changes may be made which will readily suggest themselves to those skilled in the art and which are encompassed within the spirit of the invention disclosed in the above text and in the accompanying drawings.

We claim:

1. A shish kabob apparatus for cooking food items over a heat source, comprising:
a planar support supportable proximate to the heat source;
a number of skewer members each comprising an elongated body portion with a proximal end and a distal end, the distal end configured to pierce the food items to facilitate stacking of said food items along the elongated body portion portion; and
first means for removably affixing the proximal end of each skewer member to the planar support to support each skewer member along an axis that is substantially normal to the planar support during the cooking of said food items.

2. A shish kabob apparatus of claim 1, wherein the first means comprises a number of support members affixed to the planar support, each support member engaging the proximal end of a corresponding one of the skewer members.

3. A shish kabob apparatus of claim 1, wherein the skewer members are arranged in at least two rows of at least three skewer members each on the planar support.
